(19) United States
(12) Patent Application Publication
(10) Pub. No.: US 2016/0132935 A1
(43) Pub. Date: May 12, 2016

(54) SYSTEMS, METHODS, AND APPARATUS FOR FLEXIBLE EXTENSION OF AN AUDIENCE SEGMENT

(71) Applicant: Turn Inc., Redwood City, CA (US)

(72) Inventors: Jianqiang Shen, Redwood City, CA (US); Ali Dasdan, Redwood City, CA (US)

(73) Assignee: Turn Inc., Redwood City, CA (US)

(21) Appl. No.: 14/536,519

(22) Filed: Nov. 7, 2014

(51) Int. Cl. G06Q 30/02

(52) U.S. Cl. CPC G06Q 30/0269; G06Q 30/0277; G06Q 30/0275

(57) ABSTRACT

Systems, methods, and devices are disclosed herein for identifying, analyzing, and extending audiences associated with online advertising. Systems include a first processing node configured to generate a first plurality of data categories that includes a plurality of seed data categories. Systems include a query node configured to retrieve a second plurality of data categories that includes a plurality of candidate data categories. Systems include a second processing node configured to generate a plurality of relevance metrics including a relevance metric for each candidate data category based on a comparison between each of the plurality of seed data categories and each of the plurality of candidate data categories. Systems include a third processing node configured to generate a third plurality of data categories that includes at least some of the seed data categories and at least some of the candidate data categories based on the generated plurality of relevance metrics.

### TECHNICAL FIELD

This disclosure generally relates to online advertising, and more specifically to identifying, analyzing, and extending audiences associated with online advertising.

### BACKGROUND

In online advertising, internet users are presented with advertisements as they browse the internet using a web browser or mobile application. Online advertising is an efficient way for advertisers to convey advertising information to potential purchasers of goods and services. It is also an efficient tool for non-profit/political organizations to increase the awareness in a target group of people. The presentation of an advertisement to a single internet user is referred to as an ad impression.

Billions of display ad impressions are purchased on a daily basis through public auctions hosted by real time bidding (RTB) exchanges. In many instances, a decision by an advertiser regarding whether to submit a bid for a selected RTB ad request is made in milliseconds. Advertisers often try to buy a set of ad impressions to reach as many targeted users as possible. Advertisers may seek an advertiser-specific action from advertisement viewers. For instance, an advertiser may seek to have an advertisement viewer purchase a product, fill out a form, sign up for e-mails, and/or perform some other type of action. An action desired by the advertiser may also be referred to as a conversion.

### SUMMARY

Systems, methods, and apparatus are disclosed herein for identifying, analyzing, and extending audiences associated with online advertising. In various embodiments, the systems may include a first processing node configured to generate a first plurality of data values identifying a first plurality of data categories, where the first plurality of data categories includes a plurality of seed data categories identifying a set of characteristics of a first plurality of users associated with an advertisement campaign. The systems may also include a query node configured to retrieve a second plurality of data values identifying a second plurality of data categories, where the second plurality of data categories including a plurality of candidate data categories identifying a set of characteristics of a second plurality of users associated with historical data aggregated from a plurality of advertisement campaigns. The systems may further include a second processing node configured to generate a plurality of relevance metrics including a relevance metric for each candidate data category of the plurality of candidate data categories based on a comparison between each of the plurality of seed data categories and each of the plurality of candidate data categories. The systems may also include a third processing node configured to generate a third plurality of data values identifying a third plurality of data categories, where the third plurality of data categories including at least some of the plurality of seed data categories and at least some of the plurality of candidate data categories based on the generated plurality of relevance metrics.

In some embodiments, the plurality of seed data categories are identified based on a plurality of targeting criteria associated with the advertisement campaign. In various embodiments, the second processing node is further configured to generate a plurality of similarity metrics including a similarity metric for each candidate data category of the plurality of candidate data categories, where each similarity metric of the plurality of similarity metrics identifies a probability that a seed data category of the plurality of seed data categories is associated with the same user as a candidate data category of the plurality of candidate data categories. In various embodiments, the second processing node is further configured to generate a plurality of novelty metrics including a novelty metric for each candidate data category of the plurality of candidate data categories, where each novelty metric of the plurality of novelty metrics identifies a probability that a candidate data category of the plurality of candidate data categories is associated with a different user as a seed data category of the plurality of seed data categories. In various embodiments, the second processing node is further configured to generate a plurality of performance metrics including a performance metric for each candidate data category of the plurality of candidate data categories based on a return on investment associated with an advertisement campaign that includes the candidate data category.

In some embodiments, the system further includes a fourth processing node configured to generate a plurality of weighted parameters including a weighted parameter for each of the plurality of similarity metrics, the plurality of novelty metrics, and the plurality of performance metrics for each combination of the plurality of seed data categories and the plurality of candidate data categories. The systems may also include a fifth processing node configured to generate a fourth plurality of data values identifying a plurality of relevance scores based on the plurality of weighted parameters, where the plurality of relevance scores includes a relevance score for each combination of the plurality of seed data categories and the plurality of candidate data categories. In various embodiments, the third plurality of data categories is identified based, at least in part, on the plurality of relevance scores. In some embodiments, the fourth processing node is further configured to modify at least one of the plurality of weighted parameters, and the fifth processing node is further configured to generate a fifth plurality of data values identifying a plurality of updated relevance scores based, at least in part, on the received at least one modification.

In some embodiments, the modifying of the at least one of the plurality of weighted parameters is based, at least in part, on historical data characterizing at least one previous modification. In various embodiments, the third processing node is further configured to generate a sixth plurality of data values identifying a fourth plurality of data categories, where the fourth plurality of data categories includes at least some of the plurality of seed data categories and at least some of the plurality of candidate data categories, where the fourth plurality of data categories is identified based, at least in part, on the plurality of updated relevance scores. The systems may also include a sixth processing node configured to generate a graphical representation of fourth plurality of data categories, and further configured to send the graphical representation to a display device associated with a user. In various embodiments, the first processing node, the second processing node, and the third processing node are the same processing node.

Also disclosed herein are devices that may include an audience segment analyzer configured to generate a first plurality of data values identifying a first plurality of data categories, where the first plurality of data categories includes a plurality of seed data categories identifying a set of characteristics of a first plurality of users associated with an advertisement campaign. In some embodiments, the audience segment analyzer may be further configured to retrieve, via a communications interface, a second plurality of data values identifying a second plurality of data categories, where the second plurality of data categories includes a plurality of candidate data categories identifying a set of characteristics of a second plurality of users associated with historical data aggregated from a plurality of advertisement campaigns. In various embodiments, the audience segment analyzer may be further configured to generate a plurality of relevance metrics including a relevance metric for each candidate data category of the plurality of candidate data categories based on a comparison between each of the plurality of seed data categories and each of the plurality of candidate data categories. In some embodiments, the audience segment analyzer may be further configured to generate a third plurality of data values identifying a third plurality of data categories, where the third plurality of data categories includes at least some of the plurality of seed data categories and at least some of the plurality of candidate data categories based on the generated plurality of relevance metrics.

In some embodiments, the audience segment analyzer may be further configured to execute one or more instructions to generate a plurality of similarity metrics including a similarity metric for each candidate data category of the plurality of candidate data categories, where each similarity metric of the plurality of similarity metrics identifies a probability that a seed data category of the plurality of seed data categories is associated with the same user as a candidate data category of the plurality of candidate data categories. The audience segment analyzer may be further configured to execute one or more instructions to generate a plurality of novelty metrics including a novelty metric for each candidate data category of the plurality of candidate data categories, where each novelty metric of the plurality of novelty metrics identifies a probability that a candidate data category of the plurality of candidate data categories is associated with a different user as a seed data category of the plurality of seed data categories. In some embodiments, the audience segment analyzer may be further configured to execute one or more instructions to generate a plurality of performance metrics including a performance metric for each candidate data category of the plurality of candidate data categories based on a return on investment associated with an advertisement campaign that includes the candidate data category. In various embodiments, the audience segment analyzer may be further configured to execute one or more instructions to generate a plurality of weighted parameters including a weighted parameter for each of the plurality of similarity metrics, the plurality of novelty metrics, and the plurality of performance metrics for each combination of the plurality of seed data categories and the plurality of candidate data categories. The audience segment analyzer may be further configured to generate a fourth plurality of data values identifying a plurality of relevance scores based on the plurality of weighted parameters, where the plurality of relevance scores includes a relevance score for each combination of the plurality of seed data categories and the plurality of candidate data categories. In some embodiments, the third plurality of data categories is identified based, at least in part, on the plurality of relevance scores.

Also disclosed herein are one or more computer readable media having instructions stored thereon for performing a method, the method including generating a first plurality of data values identifying a first plurality of data categories, where the first plurality of data categories including a plurality of seed data categories identifying a set of characteristics of a first plurality of users associated with an advertisement campaign. The methods may also include retrieving a second plurality of data values identifying a second plurality of data categories, where the second plurality of data categories includes a plurality of candidate data categories identifying a set of characteristics of a second plurality of users associated with historical data aggregated from a plurality of advertisement campaigns. The methods may also include generating a plurality of relevance metrics including a relevance metric for each candidate data category of the plurality of candidate data categories based on a comparison between each of the plurality of seed data categories and each of the plurality of candidate data categories. The methods may further include generating a third plurality of data values identifying a third plurality of data categories, where the third plurality of data categories includes at least some of the plurality of seed data categories and at least some of the plurality of candidate data categories based on the generated plurality of relevance metrics. In some embodiments, the plurality of seed data categories are identified based on a plurality of targeting criteria associated with the advertisement campaign.

Details of one or more embodiments of the subject matter described in this specification are set forth in the accompanying drawings and the description below. Other features, aspects, and advantages will become apparent from the description, the drawings, and the claims.

### BRIEF DESCRIPTION OF THE DRAWINGS

FIG. 1 illustrates an example of a system for generating an audience recommendation, implemented in accordance with some embodiments.

FIG. 2 illustrates an example of an advertiser hierarchy, implemented in accordance with some embodiments.

FIG. 3 illustrates a flow chart of an example of an audience recommendation generation method, implemented in accordance with some embodiments.

FIG. 4 illustrates a flow chart of an example of a data processing method, implemented in accordance with some embodiments.

FIG. 5 illustrates a flow chart of an example of a recommendation generation method, implemented in accordance with some embodiments.

FIG. 6 illustrates a flow chart of an example of a recommendation updating method, implemented in accordance with some embodiments.

FIG. 7 illustrates a flow chart of an example of another recommendation updating method, implemented in accordance with some embodiments.

FIG. 8 illustrates and example of a user interface screen implemented in accordance with some embodiments.

FIG. 9 illustrates a data processing system configured in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific examples, it will be understood that these examples are not intended to be limiting.

In online advertising, advertisers often try to provide the best ad for a given user in an online context. Advertisers often set constraints which affect the applicability of the advertisements, which may also be referred to herein as ads. For example, an advertiser might try to target only users in a particular geographical area or region who may be visiting web pages of particular types for a specific campaign. Thus, an advertiser may try to configure a campaign to target a particular group of end users, which may be referred to herein as an audience. As used herein, a campaign may be an advertisement strategy which may be implemented across one or more channels of communication. Furthermore, the objective of advertisers may be to receive as many user actions as possible by utilizing different campaigns in parallel. As previously discussed, an action may be the purchase of a product, filling out of a form, signing up for e-mails, and/or some other type of action. In some embodiments, actions or user actions may be advertiser-defined and may include an affirmative act performed by a user, such as inquiring about or purchasing a product and/or visiting a certain page.

In various embodiments, an ad from an advertiser may be shown to a user with respect to publisher content, which may be a website or mobile application if the value for the ad impression opportunity is high enough to win in a real-time auction. Advertisers may determine a value associated with an ad impression opportunity by determining a bid. In some embodiments, such a value or bid may be determined based on the probability of receiving an action from a user in a certain online context multiplied by the cost-per-action goal an advertiser wants to achieve. Once an advertiser, or one or more demand-side platforms that act on their behalf, wins the auction, it is responsible to pay the amount that is the winning bid.

As similarly discussed above, to improve the effectiveness of marketing or advertisement campaigns, an advertiser may create an audience segment to target a specific population. As used herein, an audience segment may be a set of rules and/or conditions that specify one or more features of users that ideally should be included or excluded from the target audience of an advertisement campaign or sub-campaign. In various embodiments, the audience segment may be applied over various 1st and 3rd party data associated with the user. A user may be analyzed by applying the audience segment rule set to the user's collected data. If the rule set returns “true” and the user satisfies the conditions set forth in the rule set, the user is a targeted user and may be served advertisements from the advertiser. Such advertisements are not served to users who do not satisfy the rule set and return “false.”

An advertiser may attempt to modify the previously created audience segment to adjust the target audience that is served content by its associated advertisement campaign. This may be the case when a population covered by the audience segment is too small and the advertiser is not able to spend its entire budget, or if a cost for obtaining and using 3rd party data is too high and the advertiser is seeking other options. In these situations, conventional techniques remain limited because the advertiser must manually decide what changes should be made to the audience segment without much, if any, additional information. Accordingly, such techniques can involve a large amount of guess-work and trial and error to ascertain the results of such modifications. Furthermore, such techniques are limited to the knowledge of the advertiser because the advertiser has no other available information upon which to operate. For at least these reasons, conventional techniques provide an inefficient and ineffective way of modifying an audience segment.

Various systems, methods, and apparatus disclosed herein for generating a recommended audience extension for an advertisement campaign and/or sub-campaign. As disclosed herein, a system may receive and process an audience segment from an entity, such as an advertiser. The audience segment may be processed to identify several seed data categories which may be used as “seeds” to identify other relevant data categories which may be used to expand and enhance the audience segment itself. Thus, several candidate data categories may be retrieved and analyzed. For example, various relevance metrics, such as similarity metrics, novelty metrics, and performance metrics, may be calculated for each candidate data category with respect to the seed data categories. Based on the calculated metrics and some associated weighted parameters which may be configured by the advertiser, several candidate data categories may be identified as relevant, and may be included in a recommendation for an expanded audience segment. Thus, the advertiser may be provided with a recommendation that includes new additional data categories that are relevant to the audience segment that was initially provided, and further expand the target audience of the audience segment. Moreover, the advertiser may be provided with estimations of costs, a number of users reached, as well as various other features of each recommended audience segment. In this way, various embodiments disclosed herein efficiently and effectively provide an entity, such as an advertiser, with recommendations for additional data categories to include in the audience segment. Such recommendations may be based upon tens of thousands of different categories stored in the systems disclosed herein, thus providing recommendations based on information that exceeds the information available to the advertiser himself or herself. Moreover, the advertiser may be presented with projections and forecasts of costs and benefits for each different recommendation.

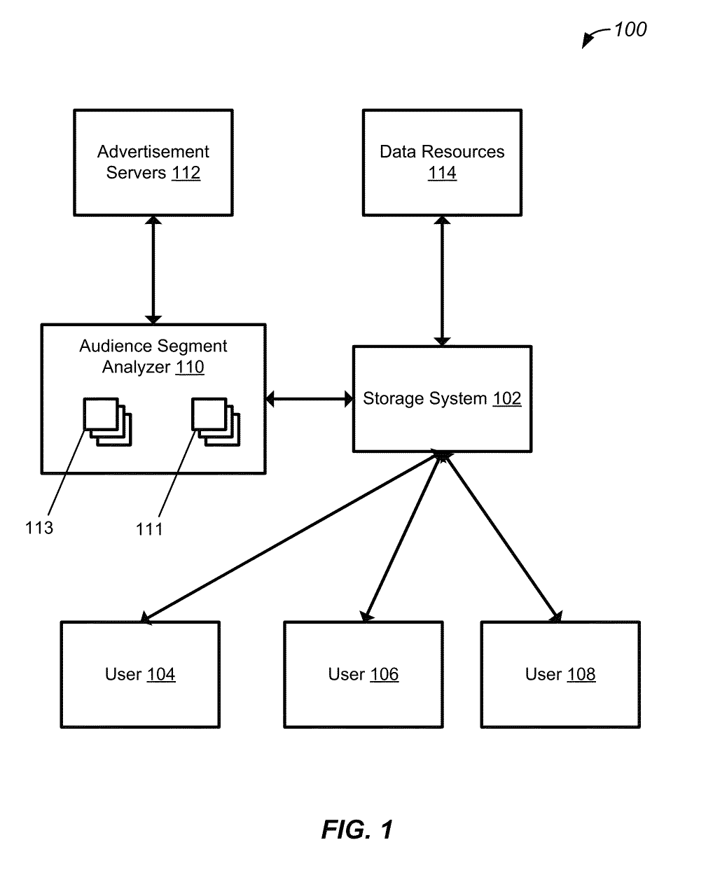

FIG. 1 illustrates an example of a system for generating an audience recommendation, implemented in accordance with some embodiments. As similarly discussed above, a system, such as system 100, may be configured to analyze an audience segment associated with an advertisement campaign, and may be further configured to identify relevant candidate data categories to potentially add to the audience segment to augment the audience segment and expand the target audience of the advertisement campaign associated with the audience segment. As will be discussed in greater detail below, relevant candidate data categories may be identified based on various metrics associated with those candidate data categories. One or more system components may be configured to include at least some of the candidate data categories in the audience segment based on an analysis of the metrics, thus expanding the available relevant users targeted by the advertisement campaign.

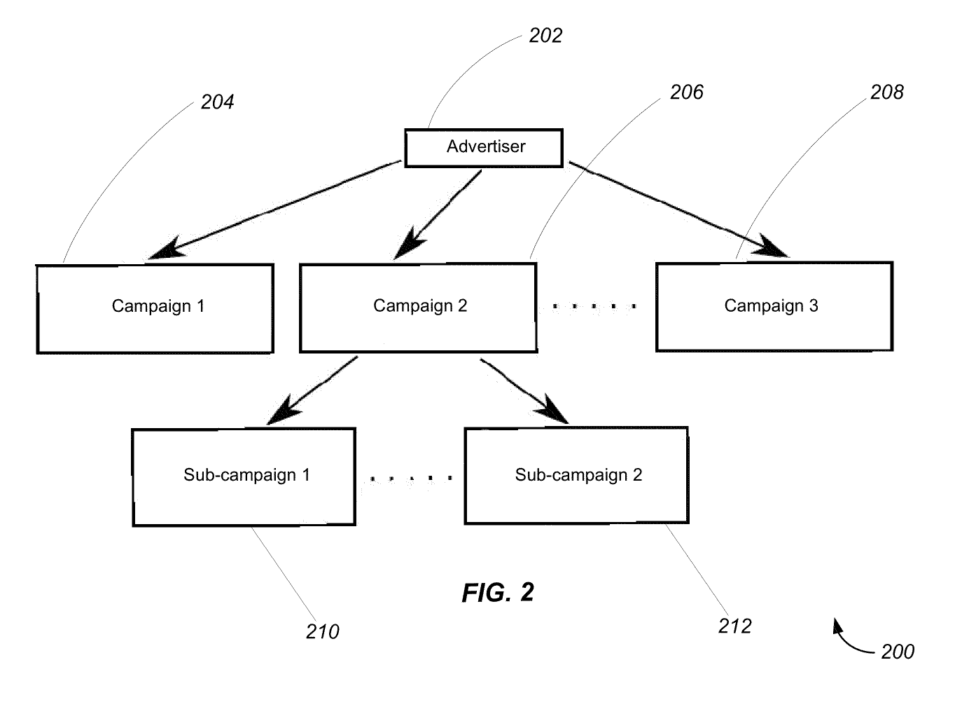

Accordingly, system 100 may be communicatively coupled with various different users, such as user 104, user 106 and user 108. As similarly discussed above, users may be users of various communications devices such as computer systems, mobile communications devices, and tablet personal computers (PCs). The communications devices may be communicatively coupled to one or more components of system 100, such as storage system 102 discussed in greater detail below. Accordingly, the communications devices may include communications interfaces that may be configured to communicate with the other system components via a communications network or the Internet. As similarly stated above, the users may be consumers having various features or characteristics, such as an age, gender, and type of purchaser. Moreover, each user may have associated data that has been aggregated based on the user's online activities. For example, user data may include an online shopping history, a list of purchases, social media profile information, and a list of interactions between the user and one or more advertisement campaigns, discussed in greater detail below with reference to FIG. 2. In some embodiments, interactions between the user and an advertisement campaign may include the user viewing and/or clicking on an advertisement.

In various embodiments, system 100 further includes storage system 102 which may include one or more storage devices configured to store data, such as the previously described user data, as well as other data utilized and generated by system 100. In some embodiments, storage system 102 may be a database system that is configured to execute queries on large amounts of data that may be stored for millions of users. In some embodiments, storage system 102 is a distributed database system. Moreover, storage system 102 may be implemented as a distributed file system. For example, storage system 102 may be implemented as a Hadoop Distributed File System (HDFS) and may be configured to provide high throughput access to the large data sets which may be in excess of several terabytes and may be associated with billions of users.

In some embodiments, storage system 102 may be communicatively coupled to data resources 114 which may be other or additional sources of data associated with users such as user 104, user 106 and user 108. For example, data resources 114 may be third party data providers or aggregators that aggregate and store large amounts of data that may be analyzed to generate a profile for a particular user. For example, a first data provider may have demographic information about many users, while a second data provider may have shopping or commercial transaction information for those users, and a third data provider may have travel information regarding those users. Examples of such data providers are DataLogix®, Epsilon, and eXelate®. In various embodiments, storage system 102 may be communicatively coupled with data resources 114, and may be configured to retrieve and store data from data resources 114 within storage system 102.

In some embodiments, system 100 is communicatively coupled with advertisement servers 112 which may be configured to perform one or more advertisement operations. For example, advertisement servers 112 may be configured to store budget data associated with one or more advertisement campaigns, and may be further configured to implement the one or more advertisement campaigns over a designated period of time. In some embodiments, the implementation of the advertisement campaign may include identifying actions or communications channels associated with users targeted by advertisement campaigns, placing bids for impression opportunities, and serving content upon winning a bid. In some embodiments, the content may be advertisement content, such as an Internet advertisement banner, which may be associated with a particular advertisement campaign. The terms “advertisement server” and “advertiser” are used herein generally to describe systems that may include a diverse and complex arrangement of systems and servers that work together to display an advertisement to a user's device. For instance, this system will generally include a plurality of servers and processing nodes for performing different tasks, such as bid management, bid exchange, advertisement and campaign creation, content publication, etc.

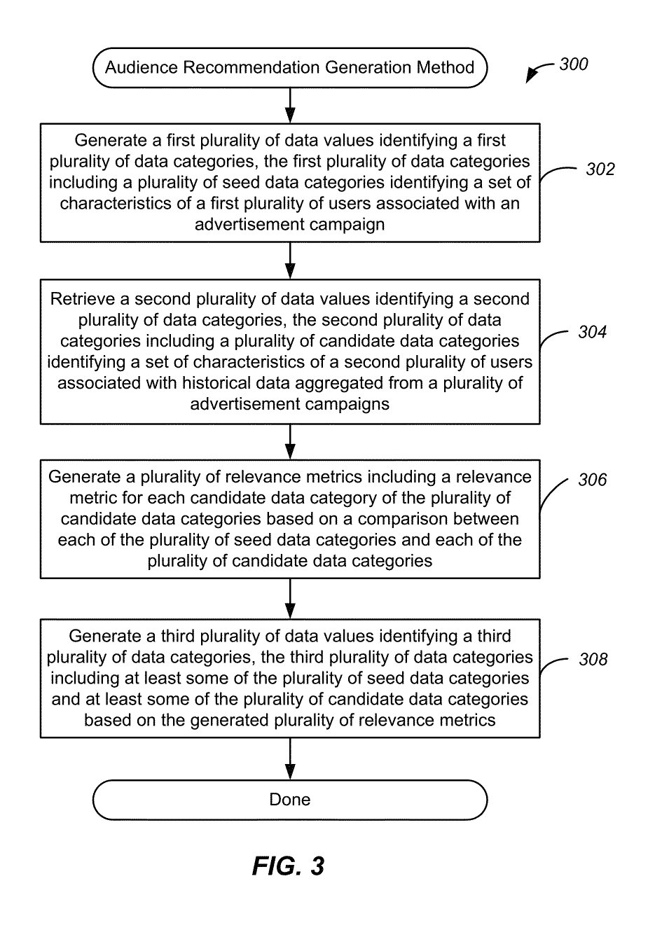

In various embodiments, system 100 includes audience segment analyzer 110 which may include one or more processing devices configured to analyze audience segments associated with advertisement campaigns. Thus, audience segment analyzer 110 may be configured to identify seed data categories, process candidate data categories, and generate recommendations for audience segment extensions based on the processing of the candidate data categories, as will be discussed in greater detail below with reference to FIGS. 3-9. In some embodiments, audience segment analyzer 110 may include one or more communications interfaces configured to communicatively couple audience segment analyzer 110 to other components and entities, such as storage system 102 and advertisement servers 112. Furthermore, as similarly stated above, audience segment analyzer 110 may include one or more processing devices specifically configured to process user data associated with users and data categories associated with the users. In one example, the audience segment analyzer includes at least one query node and a plurality of big data processing nodes for processing large amounts of audience or user data based on queries from a query node in a distributed manner. For example, audience segment analyzer 110 may include one or more query nodes, such as query node 111, to handle queries associated with storage system 102, and may further include several processing nodes, such as processing node 113, configured to handle processing operations on large data sets. Any suitable number of nodes may be included in audience segment analyzer 110. For example, audience segment analyzer 110 may include first, second, third, fourth, fifth, and sixth processing nodes. In one specific embodiment, audience segment analyzer 110 may include one or more application specific processors implemented in application specific integrated circuits (ASICs) that may be specifically configured to process large amounts of data in complex data sets, as may be found in the context generally referred to as “big data.”

In some embodiments, the one or more processors may be implemented in one or more reprogrammable logic devices, such as a field-programmable gate array (FPGAs), which may also be similarly configured. According to various embodiments, audience segment analyzer 110 may include a dedicated processing unit that includes one or more hardware accelerators configured to perform recommendation operations and adjustments that may occur dynamically. For example, as discussed in greater detail below, operations associated with the generation of recommendations as well as adjustment of recommendations responsive to an input from an advertiser may be processed, at least in part, by one or more hardware accelerators included in audience segment analyzer 110.

In various embodiments, such large data processing contexts may involve user data stored across multiple servers implementing one or more redundancy mechanisms configured to provide fault tolerance for the user data. In some embodiments, a MapReduce-based framework or model may be implemented to analyze and process the large data sets disclosed herein. Furthermore, various embodiments disclosed herein may also utilize other frameworks, such as .NET or grid computing.

FIG. 2 illustrates an example of an advertiser hierarchy, implemented in accordance with some embodiments. As previously discussed, advertisement servers may be used to implement various advertisement campaigns to target various users or an audience. In the context of online advertising, an advertiser, such as the advertiser 202, may display or provide an advertisement to a user via a publisher, which may be a web site, a mobile application, or other browser or application capable of displaying online advertisements. The advertiser 202 may attempt to achieve the highest number of user actions for a particular amount of money spent, thus maximizing the return on the amount of money spent. Accordingly, the advertiser 202 may create various different tactics or strategies to target different users. Such different tactics and/or strategies may be implemented as different advertisement campaigns, such as campaign 204, campaign 206, and campaign 208, and/or may be implemented within the same campaign. Each of the campaigns and their associated sub-campaigns may have different targeting rules which may be referred to herein as an audience segment. For example, a sports goods company may decide to set up a campaign, such as campaign 204, to show golf equipment advertisements to users above a certain age or income, while the advertiser may establish another campaign, such as campaign 206, to provide sneaker advertisements towards a wider audience having no age or income restrictions. Thus, advertisers may have different campaigns for different types of products. The campaigns may also be referred to herein as insertion orders.

Each campaign may include multiple different sub-campaigns to implement different targeting strategies within a single advertisement campaign. In some embodiments, the use of different targeting strategies within a campaign may establish a hierarchy within an advertisement campaign. Thus, each campaign may include sub-campaigns which may be for the same product, but may include different targeting criteria and/or may use different communications or media channels. Some examples of channels may be different social networks, streaming video providers, mobile applications, and web sites. For example, the sub-campaign 210 may include one or more targeting rules that configure or direct the sub-campaign 210 towards an age group of 18-34 year old males that use a particular social media network, while the sub-campaign 212 may include one or more targeting rules that configure or direct the sub-campaign 212 towards female users of a particular mobile application. As similarly stated above, the sub-campaigns may also be referred to herein as line items.

Accordingly, an advertiser 202 may have multiple different advertisement campaigns associated with different products. Each of the campaigns may include multiple sub-campaigns or line items that may each have different targeting criteria. Moreover, each campaign may have an associated budget which is distributed amongst the sub-campaigns included within the campaign to provide users or targets with the advertising content.

FIG. 3 illustrates a flow chart of an example of an audience recommendation generation method, implemented in accordance with some embodiments. In various embodiments, an audience segment associated with an advertisement campaign may be analyzed to identify relevant candidate data categories which may potentially be added to the audience segment to augment the audience segment and expand the target audience of the advertisement campaign itself. Accordingly, relevant candidate data categories may be identified based on various metrics associated with those candidate data categories. At least some of the candidate data categories may be included in the audience segment based on an analysis of the metrics, thus enabling the expansion of available relevant end users who may be targeted by the advertisement campaign.

Accordingly, method 300 may commence with operation 302 during which a first plurality of data values identifying a first plurality of data categories may be generated. In some embodiments, the first plurality of data categories may include seed data categories identifying a set of characteristics of a first plurality of users associated with an advertisement campaign. Thus, seed data categories may be data categories included in an audience segment which may have been previously generated by an advertiser. Accordingly, the seed data categories may be received from one or more system components, such as advertisement servers. In some embodiments, the seed data categories may be generated by an audience segment analyzer that may be configured to analyze received audience segments, and parse seed data categories from the received audience segments.

Method 300 may proceed to operation 304 during which a second plurality of data values identifying a second plurality of data categories may be received. In various embodiments, the second plurality of data categories may include a plurality of candidate data categories identifying a set of characteristics of a second plurality of users associated with historical data aggregated from a plurality of advertisement campaigns. In some embodiments, the candidate data categories may be retrieved from a database that stores all data categories available to the system. In various embodiments, the candidate data categories may be retrieved from a local file, or a file stored in a distributed file system. Thus, according to some embodiments, all known data categories may be retrieved and used as candidate data categories. In some embodiments, the second set of data categories for this second set of historical users may include the first plurality of data categories that were obtained for the first set of users. In various embodiments, the candidate data categories may be retrieved by a system component, such as the audience segment analyzer.

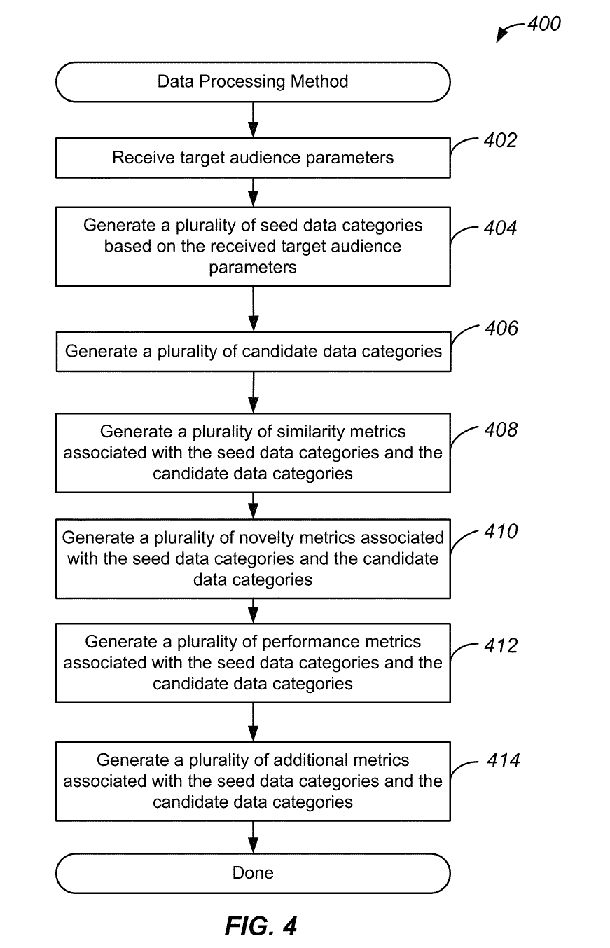

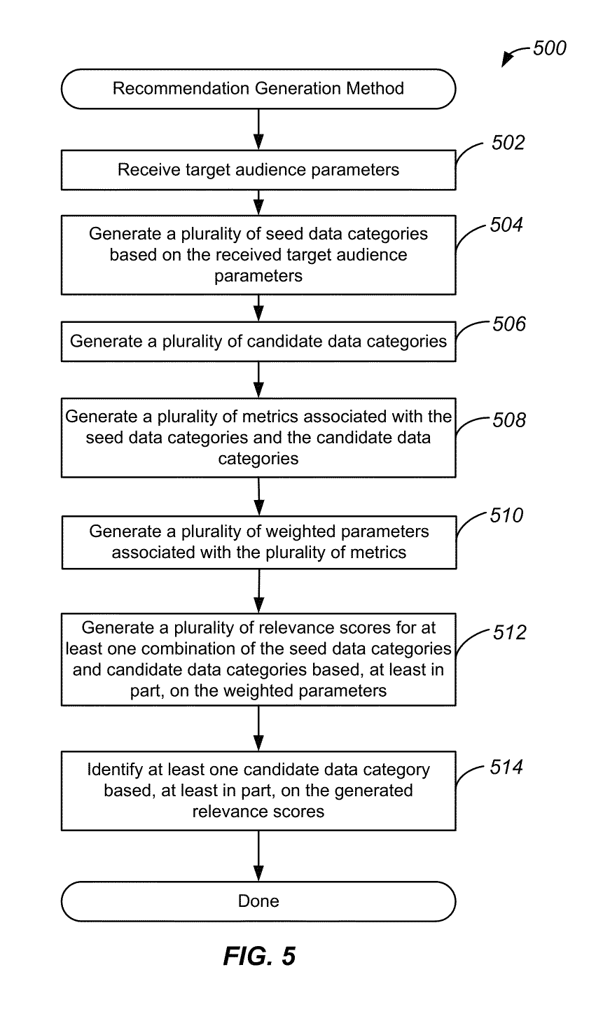

Method 300 may proceed to operation 306 during which a plurality of relevance metrics may be generated. In some embodiments, the relevance metrics may include a relevance metric for each candidate data category of the plurality of candidate data categories. The relevance metrics may be generated based on a comparison between each of the plurality of seed data categories and each of the plurality of candidate data categories. Thus, as will be discussed in greater detail below with reference to FIG. 4 and FIG. 5, each candidate data category may be compared with each seed data category to determine relevance metrics describing or characterizing how relevant the candidate data category is to the seed data category.

Method 300 may proceed to operation 308 during which a third plurality of data values identifying a third plurality of data categories may be generated. In some embodiments, the third plurality of data categories may include at least some of the plurality of seed data categories and at least some of the plurality of candidate data categories based on the generated plurality of relevance metrics. Thus, the third plurality of data categories may represent a new or recommended audience segment that includes some of the seed data categories as well as some of the candidate data categories. The added candidate data categories may be included based on the previously generated relevance metrics. Accordingly, relevant candidate data categories may be added to expand the audience segment associated with an advertisement campaign, and expand the target audience that is reached by the advertisement campaign.

FIG. 4 illustrates a flow chart of an example of a data processing method, implemented in accordance with some embodiments. In various embodiments, a data processing method, such as method 400, may process various data associated with advertisement campaigns to identify various candidate data categories that may be capable of expanding a target audience of one or more advertisement campaigns. Moreover, the data processing method may generate various metrics that characterize features, such as similarity, novelty, and performance, for each candidate data category. As will be discussed in greater detail below with reference to FIG. 5, such metrics may form the underlying basis of generating a new expanded target audience that enables an advertiser to reach more users than previously possible. In some embodiments, method 400 is performed as an ongoing process in which metrics are continuously calculated and updated as new advertisement data is received.

Method 400 may commence with operation 402 during which target audience parameters may be received. The target audience parameters may be included in an audience segment associated with an advertisement campaign. In some embodiments, the audience segment is a user-defined segment. For example, the audience segment may be a declaration or rule statement generated by an advertiser when initially creating the advertisement campaign. The user-defined segment may include one or more data values that identify data categories associated with users. The data categories may be criteria and features of a target audience for the advertisement campaign or sub-campaign. In some embodiments, the data categories may be data values or labels assigned to users by data providers. For example, an advertiser may specify a gender, age group, type of purchaser or buyer, category of purchase, as well as various other features of end users who may potentially be part of the audience. The advertiser may also specify data sources associated with these criteria. Moreover, various logic operations, such as “AND” and “OR,” may also be included in the audience segment. An example of such a user-defined segment is provided below:

((DataLogix: 20<age<30) AND (Epsilon: recent car buyer)) OR (eXelate: frequent traveler)

In this example, several databases associated with data providers, such as DataLogix®, Epsilon, and eXelate®, have been specified. Moreover, particular categories have been specified for each one, such as an age group, recent purchaser, or recent/frequent traveler. Such categories or labels may be determined by a system component, such as an audience segment analyzer, or may be provided by the data providers themselves. Users who satisfy these criteria are targeted by the campaign and are part of its audience. Moreover, the segment may include logical operators such as “AND” and “OR” which define logical relationships between the data sources. Accordingly, during operation 402 an audience segment that includes audience target parameters, such as data categories and associated logical operators, may be retrieved from a database system or received from another suitable source by a system component, such as an audience segment analyzer.

Method 400 may proceed to operation 404 during which a plurality of seed data categories may be generated based on the received target audience parameters. In various embodiments, the segment received during operation 402 may be processed to identify one or more seed data categories. For example, the data categories included in the received user-defined segment may be parsed from the segment and used as seed data categories. In another example, the user-defined segment may be further processed. For example, the segment may be converted into conjunctive normal form. Thus, a conjunction may be taken of disjunctive clauses or simple clauses. In this example, negated data categories may be ignored, and the positively identified data categories may be retained as seed data categories.

Method 400 may proceed to operation 406 during which a plurality of candidate data categories may be generated. In some embodiments, the candidate data categories may be generated based on known labels or data categories available to a system component, such as the audience segment analyzer. As similarly discussed above, a database system may store known labels or data categories that may have been provided by various entities, such as data providers. Thus, all data categories used by data providers may be logged and stored in a database system. In some embodiments, the data categories may be retrieved and may be used as candidate data categories. Thus, according to some embodiments, the candidate data categories include all data categories known to a system component, such as the audience segment analyzer.

Method 400 may proceed to operation 408 during which a plurality of similarity metrics may be generated. In some embodiments, the plurality of similarity metrics may be associated with the seed data categories and the candidate data categories. Thus, the similarity metrics may characterize a determination of similarity between two different data categories based on various features or patterns associated with them, such as similarities between groups of users associated with each data category respectively. In this way, historical data associated with users may be processed to generate several metrics that identify or characterize how similar different data categories are.

In various embodiments, the similarity metrics may be generated based on a probabilistic analysis. For example, for a particular pair of a seed data category and a candidate data category, a system component, such as the audience segment analyzer, may be configured to determine or calculate a conditional probability value that identifies a probability that the candidate data category will be associated with the same user as the seed category. Such a probability may be determined based on the formula provided below in equation 1:

$$P ( candidate \vert seed ) = \frac{\begin{matrix}number of users associated with both \\ candidate and seed data categories\end{matrix}}{\begin{matrix}number of users associated \\ with seed data category\end{matrix}}$$

As previously discussed, a user may have an associated data object stored in a database system. The data object may include an identifier that identifies the user, as well as several data values that identify labels or data categories that are associated with the user. As similarly discussed above, such labels or data categories may be obtained from a variety of sources, such as various different data providers. In various embodiments, the data objects may be queried to identify data objects, and users associated with the data objects, that include one or more labels or data categories. Accordingly, as shown in equation 1, a total number of users associated with both a candidate data category and a seed data category may be divided by a number of users associated with just the seed data category. Thus, the more similar the seed data category and the candidate data category are, the more likely they are to be associated with the same user, and the closer the calculated probability will be to a value of “1.” Therefore, the calculated probabilistic similarity score identifies the probability that a user will be associated with a candidate data category if that user is already associated with the seed data category. In some embodiments, smoothing techniques may be applied as well. For example, Laplacian smoothing may be implemented by adding a small value to the numerator and denominator.

In some embodiments, the similarity metrics may be generated based on a matrix analysis. For example, a matrix may be generated that has rows associated with data categories and columns associated with users. Data values stored in the matrix may identify whether or not a data category is associated with a user. A system component, such as an audience segment analyzer, may be configured to perform one or more statistical operations on the matrix, such as a matrix decomposition. In one example, the matrix decomposition may generate a semantic representation of each category by, for example, using an indexing and retrieval technique such as latent semantic indexing or non-negative matrix factorization. A decomposition may be generated that includes a first matrix and a second matrix. In the first matrix, each row may correspond to a topic distribution associated with a data category. In the second matrix, each column may correspond to a distribution of a number of users associated with each of the topics. In various embodiments, a cosine difference between topic distributions may be calculated for different pairs of categories. The negative value of the distance may be used as the similarity metric.

According to various embodiments, the similarity metrics may be generated based on a correlational analysis. In some embodiments, pairs may be made for each combination of seed data category and candidate data category and a correlation value may be calculated for each pair based on users associated with each seed data category and each candidate data category. For example, for each data category a data object may be stored that includes a vector. Each element of the vector may correspond to a different user. Data values may be stored within the vector that identify whether or not a user is associated with that category. For example, each data category vector may include a series of data values such as a “1” or a “0” that identify which users are associated with the data category, and which users are not. In some embodiments, each pair of seed and candidate data categories may be correlated to determine whether or not they are similar. For example, a Pearson correlation coefficient may be calculated for each pair and stored as a similarity metric associated with that pair.

Method 400 may proceed to operation 410 during which a plurality of novelty metrics may be generated. In some embodiments, the plurality of novelty metrics may be associated with the seed data categories and the candidate data categories. Thus, the novelty metrics may characterize a determination of novelty associated with a particular candidate data category in view of the previously generated seed data categories. In some embodiments, novelty may be important to an advertiser when attempting to expand a target audience associated with an advertisement campaign or sub-campaign. Accordingly, novelty metrics may be calculated for each candidate data category to determine how novel the candidate data categories are relative to the seed data categories. In various embodiments, the novelty metrics may be determined based on the following equations, referred to herein as equations 2 and 3:

$$P ( seed \vert candidate ) = 1 - P ( seed \vert candidate )$$

$$P ( seed \vert candidate ) = \frac{\begin{matrix}number of users associated with seed \\ and candidate data categories\end{matrix}}{\begin{matrix}number of users associated \\ with candidate data category\end{matrix}}$$

As similarly discussed above, data objects associated with users may be queried to identify data objects, and users associated with the data objects, that include one or more labels or data categories. As shown in equation 3, a total number of users associated with both seed and candidate data categories may be divided by a number of users associated with just the candidate data category. The result may be subtracted from 1. Accordingly, if the seed and candidate data categories tightly overlap and are associated with very similar groups of users, the resulting probability will be small and close to zero, thus indicating that the candidate data category has a relatively low novelty score relative to that particular seed data category. In this way, the calculated probabilistic novelty score identifies the probability that a user will not be associated with both the candidate data category and the seed data category. For example, if a candidate data category has a high novelty score, there is a very low probability that it is associated with the same user as the seed data category currently being analyzed. As similarly discussed above, smoothing techniques may be applied as well. For example, Laplacian smoothing may be implemented by adding a small value to the numerator and denominator.

Method 400 may proceed to operation 412 during which a plurality of performance metrics may be generated. In various embodiments, the plurality of performance metrics may be associated with the seed data categories and the candidate data categories. Thus, the performance metrics may characterize a determination of a performance or productivity associated with a data category as may be determined or inferred based on the performance of advertisement campaigns that include the data category. For example, a performance metric associated with a data category may identify or characterize ROIs for campaigns that include the data category. In some embodiments, the metric of performance or productivity may be configurable. For example, an advertiser may specify that the performance metric is a return on investment (ROI) score determined based on a click-through rate or a purchase rate.

In various embodiments, the performance metrics may be generated based on click and conversion data aggregated across all available advertisers. Thus, for each data category, a single click-through or action rate may be calculated across all advertisers for all campaigns that include that particular data category. In some embodiments, such a calculation may be based on historical campaign data. The calculation may include counting the number of impressions delivered to audiences or users having this data category, and counting the number of clicks/actions from audiences or users having this data category. The overall or combined click-through/action rate is the number of all clicks/actions divided by the number of all impressions provided to users targeted by those campaigns.

According to some embodiments, the performance metrics may be generated by calculating a click-through/action rate for advertisers having the same advertisement category. In some embodiments, each advertiser may be assigned an advertisement category (e.g., auto, fashion, or travel). The performance metric may be determined or calculated by counting the number of impressions or advertisements within the same advertisement category that are delivered to audiences having this data category, and counting the number of clicks/actions that resulted from those impressions. In various embodiments, the advertiser-specific ROI may be calculated by dividing the number of clicks/actions by the number of impressions for the advertisement category assigned to the advertiser.

Method 400 may proceed to operation 414 during which a plurality of additional metrics may be generated. As similarly discussed above, the plurality of additional metrics may be associated with the seed data categories and the candidate data categories. For example, the additional metrics may include cost metrics that identify a relative cost associated with the inclusion of a data category in an audience segment as may be determined based on costs incurred by advertisement campaigns that include the data category, and/or costs associated with obtaining data categories from data providers. In some embodiments, the costs may be determined based on one or more designated data values. For example, an entity, such as a data provider, may have previously defined a cost and may have stored the cost in a record as one or more data values. In various embodiments, the costs may be determined based on historical data. For example, historical data associated with transactions with data providers may be analyzed, and an average cost may be calculated and used as an estimation of cost.

In some embodiments, the additional metrics may include quality metrics that identify a relative quality or accuracy of the data categories being analyzed. Various different sources may have data having different amounts of variability or noise. For example, some data categories, such as gender, retrieved from social media accounts may be highly accurate, have relatively few errors or noise, and may have a high relative quality. Alternatively, other data categories might not be as accurate, and may have a relatively low quality. In some embodiments, a quality metric may be determined by a system component, such as an audience segment analyzer, based on an analysis of a sample of data values associated with a data category. For example, for a particular data category, such as “recent purchaser,” the audience segment analyzer may retrieve a list of users associated with or tagged by that data category. The audience segment analyzer may compare the list of users or a representative sample of the list of users to known purchasing data that may be stored in a storage system. For example, the audience segment analyzer may perform a correlational analysis of the two data sets to determine how closely they match. In some embodiments, the correlation constant may be used as the quality metric. Thus, if there is high variability between the users tagged by the data category “recent purchaser” and the actual users who have made a recent purchase, the correlation will be low, and the quality metric will be low. Alternatively, if there is low variability and a significant overlap between the users tagged by the data category “recent purchaser” and the actual users who have made a recent purchase, the correlation will be high, and the quality metric will be high. In various embodiments, a quality metric may be also determined based on a designated value which may have been previously been determined by an entity, such as an advertiser. For example, an advertiser may know that data categories retrieved from a particular source are highly accurate, and the advertiser may set the quality metric for data categories retrieved from that data source.

FIG. 5 illustrates a flow chart of an example of a recommendation generation method, implemented in accordance with some embodiments. In various embodiments, overall relevance scores may be generated for various combinations of seed data categories and candidate data categories to characterize and/or identify the most relevant candidate data categories for the seed data categories that have been provided. Once identified, the relevant candidate data categories may be included with the seed data categories to augment the group of data categories that was initially present in the original audience segment, and to expand the target audience of the advertisement campaign associated with the seed data categories. In some embodiments, the relevant data categories may be provided or displayed to an entity, such as an advertiser, as part of a recommendation that expands the target audience of the advertiser's advertisement campaign.

Method 500 may commence at operation 502 during which target audience parameters may be received. As similarly discussed above with reference to method 400, the target audience parameters may be included in an audience segment associated with an advertisement campaign, and may include various data categories and logical operators associated with those data categories. In some embodiments, the target audience parameters may have been previously received as part of a pre-computation or pre-processing process. For example, one or more operations of method 400 may have been previously performed, or may be performed in tandem with method 500. Accordingly, operation 502 may be optionally performed, or operation 502 may include retrieving the previously generated data values.

Method 500 may proceed to operation 504 during which a plurality of seed data categories may be generated based on the received target audience parameters. As discussed above with reference to method 400, the seed data categories may be extracted from the data values received or retrieved during operation 502. For example, seed data categories may be parsed from the received target audience parameters and stored in a data object. As similarly stated above, the plurality of seed data categories may have been previously identified and/or generated as part of a pre-computation or pre-processing process. Accordingly, operation 504 may be optionally performed, or operation 504 may include retrieving the previously generated seed data categories from a database system.

Method 500 may proceed to operation 506 during which a plurality of candidate data categories may be generated. As discussed above with reference to method 400, candidate data categories may be generated based on known labels or data categories available to a system component, such as the audience segment analyzer. These data categories may be retrieved and may be used as candidate data categories. As similarly discussed above, the plurality of candidate data categories may have been previously generated as part of a pre-computation or pre-processing process. Accordingly, operation 506 may be optionally, or operation 506 may include retrieving previously generated candidate data values from a database system.

Method 500 may proceed to operation 508 during which a plurality of metrics associated with the seed data categories and candidate data categories may be generated. As discussed above with reference to method 400, various relevance metrics, such as similarity metrics, novelty metrics, and performance metrics, may be generated based on a comparison or analysis of the seed data categories and candidate data categories. Moreover, according to some embodiments, the metrics may be generated as part of an ongoing and separate process, such as some embodiments of method 400. Accordingly, operation 508 may be optionally performed, or operation 508 may include retrieving previously generated relevance metrics from a database system.

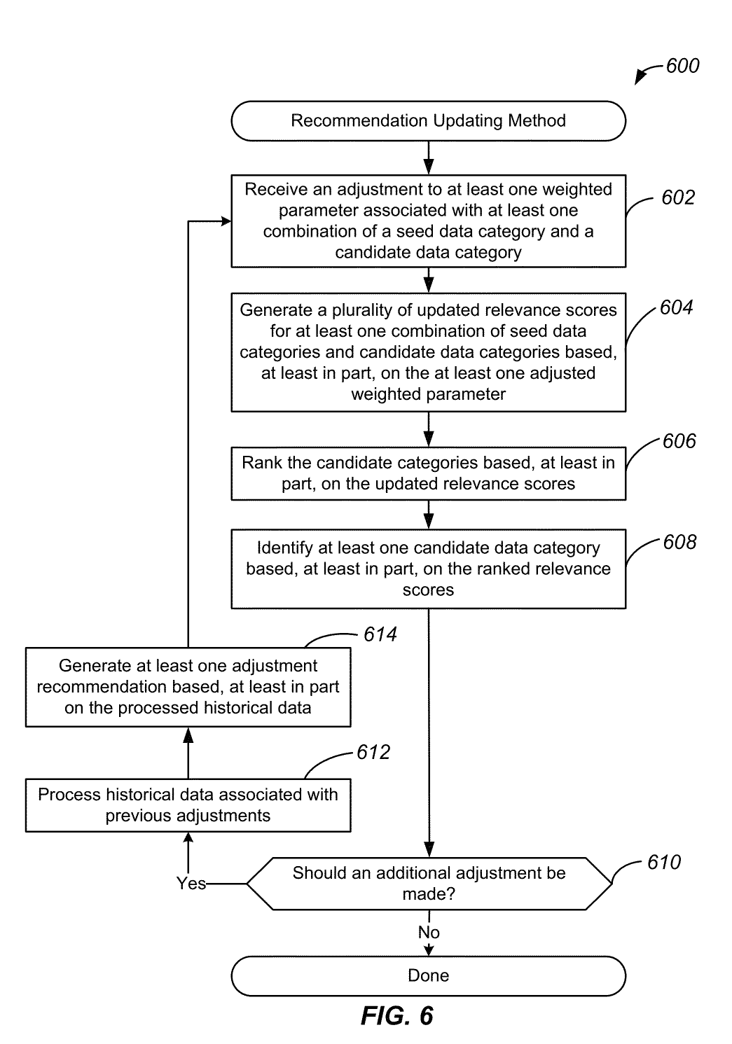

Method 500 may proceed to operation 510 during which a plurality of weighted parameters may be generated. In some embodiments, the weighted parameters may be associated with the plurality of metrics that were generated during operation 508. The weighted parameters may include a parameter for each different type of metric that was generated during operation 508. For example, a first metric may be a similarly score or metric and may have an associated first parameter w₁. Furthermore, a second metric may be a novelty score or metric and may have an associated second parameter w₂. Similarly, a third metric may be a performance score or metric and may have an associated third parameter w₃. It will be appreciated that additional parameters may be included for any additional metrics, such as quality or cost. In various embodiments, the weighted parameters may be received from an entity, such as an advertiser. Thus, the weighted parameters may have been previously defined and stored in a data object that may be retrieved during operation 510. In some embodiments, as discussed in greater detail below with reference to FIG. 6, the weighted parameters may be generated by a recommendation engine based, at least in part, on historical data associated with the target audience parameters originally received during operation 502.

Method 500 may proceed to operation 512 during which a plurality of relevance scores may be generated for at least one combination of the seed data categories and candidate data categories based, at least in part, on the weighted parameters. In some embodiments, a relevance score may be a combined overall score or metric that characterizes a likelihood or probability that a candidate data category should be included with the seed data categories that were originally identified based on the received audience segment. In some embodiments, a relevance score may characterize the relevance of a candidate data category based on the previously generated metrics and previously generated weighted parameters. An example of an equation that may be used to determine a relevance score for a particular combination of a seed data category and a candidate data category is provided below in equation 4:

f(c, S)=Max_{a∈S}(w₁*sim(c, a)+w₂*nov(c, a)+w₃*ROI(c))

As shown in equation 4, there may be a set of seed data categories S that may include a particular seed data category a. In this example, the overall relevance score for candidate data category c may be calculated relative to the entire set of seed data categories S. For example, for each combination of candidate data category c and each seed data category of set S, a score may be calculated by multiplying each relevance metric for that category pair by its weighted parameter and summing the results to generate a single score for each category pair. The maximum score from the different candidate-seed data category pairs may be stored as a relevance score for candidate data category c with respect to the entire set of seed data categories S. Accordingly, equation 4 illustrates an example of an equation or formula that may be used to calculate an overall relevance score for candidate data category c relative to a particular seed data category and/or an entire set of seed data categories, such as set S. The relevance score may be determined based on a similarity metric, a novelty metric, and a performance metric each calculated for the particular combination of candidate data category and seed data category being currently analyzed. Moreover, each of the metrics may be weighted by weighted parameters w₁, w₂, and w₃. Thus, the relevance score may be weighted to represent each type of metric to a greater or lesser degree based on the designated weighted parameters.

Moreover, according to some embodiments, a relevance score may be computed using a logarithmic scale. For example, an equation that may be used to determine a logarithmic relevance score for a particular combination of a seed data category and a candidate data category is provided below in equation 5:

f(c, S)=Max_{a∈S}(w₁*log(sim(c, a))+w₂*log(nov(c, a))+w₃* log(ROI(c)))

As similarly discussed above, equation 5 illustrates an example of an equation or formula that may be used to calculate an overall relevance score for candidate data category c relative to a particular seed data category and/or an entire set of seed data categories, such as set S. The relevance score may be determined based on a similarity metric, a novelty metric, and a performance metric each calculated for the particular combination of candidate data category and seed data category being currently analyzed. As shown in equation 5, the similarity metrics, novelty metrics, and performance metrics are represented on a logarithmic scale to account for a wide range of data values that may result from a relatively large variation within the underlying data set.

As discussed above, additional metrics may also be included in the relevance score. For example, an equation that may utilize additional metrics to determine a relevance score for a particular combination of a seed data category and a candidate data category is provided below in equation 6:

f(c, S)=Max_{a∈S}(w₁*(sim(c, a))+w₂*(nov(c, a))+w₃*(ROI(c))+w₄*cost(c))

As shown in equation 6, an additional metric, such as a cost metric, may be included in the computation of the relevance score. Moreover, an additional weighted parameter, such as w₄, may also be included to assign or attribute a relative weight or importance to the additional metric of cost. While equation 6 includes a cost metric, any suitable additional metric may also be included. For example, equation 6 may include a quality metric instead of or additional to the cost metric.

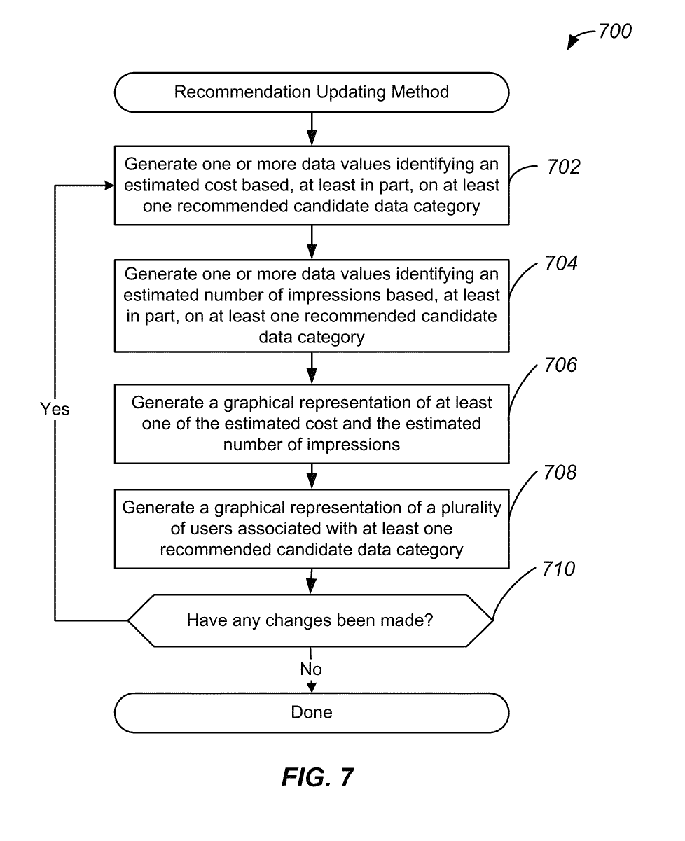

Method 500 may proceed to operation 514 during which at least one candidate data category may be identified based, at least in part, on the generated relevance scores. In some embodiments, the candidate data categories may be organized or ranked based on the generated relevance scores. For example, the candidate data categories may be ranked in descending order. In various embodiments, a designated number of candidate data categories may be identified based on their rank. For example, the candidate data categories having the 20 highest relevance scores may be identified. In some embodiments, the identified candidate data categories may be included with the seed data categories as part of an automatic process. In various embodiments, the identified candidate data categories may be included in a recommendation for an audience extension, as will be discussed in greater detail below with reference to FIG. 6 and FIG. 7.

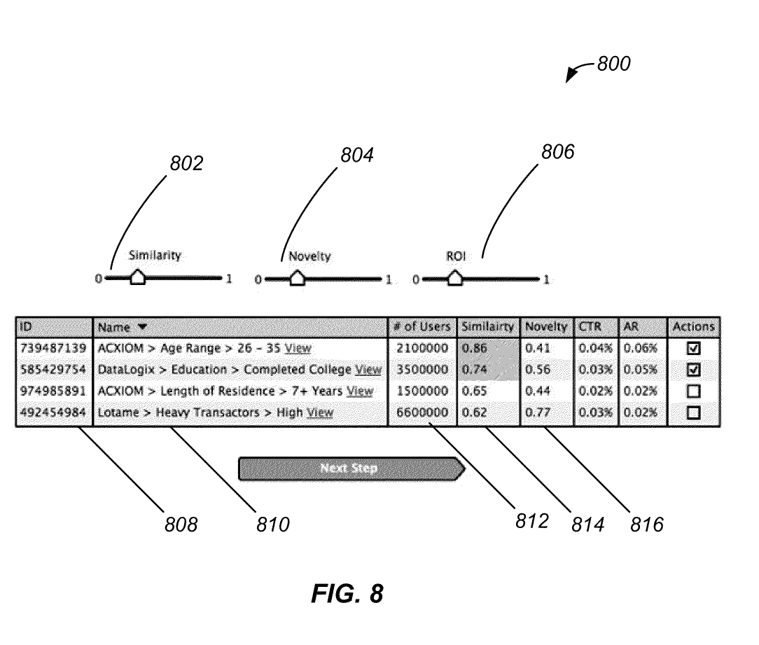

FIG. 6 illustrates a flow chart of an example of a recommendation updating method, implemented in accordance with some embodiments. As similarly discussed above, an entity, such as an advertiser, may be provided with recommendations of candidate data categories that may be used to augment, expand, or enhance a list of seed data categories that the entity may currently be using in an advertisement campaign. Such recommendations may be based, at least in part, on metrics characterizing relationships between the seed and candidate data categories, as well as weighted parameters associated with those metrics. In some embodiments, the weighted parameters may be dynamically modified by the entity or other system process to generate different or updated recommendations based on different weighted parameters. In this way, an advertiser may vary relative weights associated with different metrics, such as similarity, novelty, performance, and cost, to generate recommendations specific to the advertiser's preferences. In some embodiments, the recommendations may be updated numerous times to reflect several different adjustments, thus giving the advertiser a representation of how each adjustment or modification modifies the generated recommendations and target audiences defined by those recommendations, as will be discussed in greater detail below with reference to FIG. 7 and FIG. 8.

Method 600 may commence at operation 602 during which an adjustment to at least one weighted parameter may be received. As similarly discussed above with reference to FIG. 5, the at least one weighted parameter may be associated with at least one combination of a seed data category and a candidate data category. In various embodiments, the adjustment may be received from an entity, such as an advertiser. Accordingly, as discussed in greater detail below with reference to FIG. 8, the adjustment may be received from an advertiser to set or identify a particular weight associated with a particular metric used to calculate relevance scores. The adjustment may be received as an input at a system component, such as an audience segment analyzer.

Method 600 may proceed to operation 604 during which a plurality of updated relevance scores may be generated for at least one combination of seed data categories and candidate data categories based, at least in part, on the at least one adjusted weighted parameter. Accordingly, relevance scores which may have been calculated for different combinations of seed data categories and candidate data categories may be recalculated to update them based on the adjusted weighted parameters.

Method 600 may proceed to operation 606 during which the candidate categories may be ranked based, at least in part, on the updated relevance scores. Thus, the candidate data categories may be re-ranked based on their updated relevance scores. In this way, any adjustments made to weights associated with the metrics underlying the relevance scores may be reflected or represented in the updated relevance scores and the candidate data categories identified based on those relevance scores, as discussed below.

Method 600 may proceed to operation 608 during which at least one candidate data category may be identified based, at least in part, on the ranked relevance scores. As similarly discussed above, a designated number of candidate data categories may be identified based on the relative rank of their associated relevance scores. Accordingly, at least one candidate data category may be identified based on its updated rank relative to the other candidate data categories.

Method 600 may proceed to operation 610 during which it may be determined whether or not additional adjustment should be made. Such a determination may be made based on an input provided by an entity. For example, the entity may be an advertiser. The advertiser may be provided with a prompt or a display, as discussed in greater detail below with reference to FIG. 7 and FIG. 8. The advertiser may determine that additional adjustments should be made to the weighted parameters associated with the metrics, and may provide an input identifying the additional adjustment to a system component, such as an audience segment analyzer. Alternatively, the entity may provide an input that indicates no additional adjustments should be made. If it is determined that no additional adjustments should be made, method 600 may terminate. However, if it is determined that additional adjustments should be made, method 600 may proceed to operation 612.

Accordingly, during operation 612 historical data associated with previous adjustments may be processed. In some embodiments, historical data characterizing previous adjustments made to weighted parameters may be stored and maintained by a system component, such as an audience segment analyzer. In various embodiments, the historical data may have been generated during previous iterations of method 600. The historical data may have been generated by the same entity, which may be a particular advertiser. In some embodiments, the historical data may be aggregated from multiple different entities, such as a plurality or group of advertisers. Thus, the historical data may characterize adjustments and changes made by several advertisers over several iterations of a recommendation updating method. In some embodiments, the historical data may be processed or filtered to identify and retain historical data for a particular group or sub-set of entities. For example, historical data may be identified and retrieved that was generated by advertisers in a particular advertising sector or industry that have been assigned the same advertisement category, such as a fashion industry, automotive industry, or electronics industry.

Method 600 may proceed to operation 614 during which at least one adjustment recommendation may be generated based, at least in part on the processed historical data. Accordingly, previous adjustments to each metric may be analyzed and used to automatically generate recommended adjusted weighted parameters. For example, an average adjustment or value for a similarity metric may be calculated based on the historical data, and may be provided as a recommended adjustment to the weighted parameter associated with the similarity metric. In some embodiments, a recommended adjustment may be generated based on historical data associated with other advertisers. The other advertisers may be included in the same advertisement category as the advertiser currently associated with method 600. The other advertisers may have made adjustments in previous and separate iterations of a recommendation method, such as method 600. Data values identifying such adjustments may have been aggregated and stored as historical adjustment data. For example, the historical adjustment data may store adjusted weighted parameters for each advertiser. The adjustments for each metric may be averaged and presented as a recommended adjustment to the advertiser currently implementing method 600. Accordingly, once calculated, the recommended adjustment may be provided to the entity, which may be an advertiser, and method 600 may return to operation 602.

FIG. 7 illustrates a flow chart of an example of another recommendation updating method, implemented in accordance with some embodiments. In some embodiments, costs and impressions may be calculated or computed for each recommended audience extension and may be displayed to an entity, such as an advertiser. Furthermore, an illustration may be provided of a target audience for each recommended audience extension. In this way, the advertiser may be presented with a graphical representation of quantitative and qualitative features of each possible extension of the audience segment associated with the advertiser's advertisement campaign. Accordingly, the advertiser may be able to simultaneously view and compare the results or consequences of each modification, and determine which extension should actually be implemented in the advertisement campaign.

Method 700 may commence with operation 702 during which one or more data values identifying an estimated cost may be generated based, at least in part, on at least one recommended candidate data category. As similarly discussed above, a particular cost may be associated with providing an impression or opportunity to a member of a target audience. For example, placing a bid and purchasing an advertisement opportunity to display an advertisement on a webpage may cost a particular amount of money. Thus, increasing the number of audience members targeted by an advertisement campaign and the number of impressions associated with that advertisement campaign may increase the overall cost of the advertisement campaign itself. In some embodiments, a system component, such as an audience segment analyzer, may be configured to identify additional costs which may result from the inclusion of additional candidate data categories into the audience segment associated with the advertisement campaign. For example, the audience segment analyzer may be configured to determine a cost associated with each additional audience member. In one embodiment based on historical data, the audience segment analyzer may determine what the bid amounts for previous bid requests for the additional audience members would have been and whether the bids would have been winning bids so that the associated impressions would have been shown to such members. For example, for each additional audience member or user, data values identifying previously delivered advertisement impressions may be retrieved from historical data which may have been aggregated or generated during the previous implementation of one or more advertisement campaigns. An average cost may be calculated by averaging the cost of each of the previously delivered impressions. The average cost may be used as an estimate of a cost of future or potential impressions which may be provided to the user if the user is included in or targeted by the audience segment.

Method 700 may proceed to operation 704 during which one or more data values identifying an estimated number of impressions may be generated based, at least in part, on at least one recommended candidate data category. As similarly discussed above, increasing the number of audience members targeted by an advertisement campaign may also increase the number of impressions associated with that advertisement campaign. Thus, a system component, such as the audience segment analyzer, may be configured to identify a total number of additional impressions that were generated by the inclusion of the candidate data categories into the audience segment associated with the advertisement campaign. As similarly discussed above, the number of additional impressions may be estimated based on historical data associated with users tagged by or associated with the candidate data categories to be included in the audience segment.

Method 700 may proceed to operation 706 during which a graphical representation of at least one of the estimated cost and the estimated number of impressions may be generated. Thus, a graphical representation capable of being displayed on a display device of a computer system, mobile device, or other computing device, may be generated. In some embodiments, the graphical representation may include a number that identifies the additional cost associated with the extension or expansion of the audience segment. The graphical representation may also include a number that identifies the number of additional impressions generated by the extension or expansion of the audience segment. In this way, an entity, such as an advertiser, may be provided with one or more quantitative metrics of the overall costs and benefits of extending the audience segment that defines the target audience of the advertisement campaign.

Method 700 may proceed to operation 708 during which a graphical representation of a plurality of users associated with at least one recommended candidate data category may be generated. Thus, according to some embodiments, a system component, such as the audience segment analyzer, may be configured to generate a graphical representation capable of being displayed on a display device. The graphical representation may include an illustration or diagram representing some or all available users or audience members. Moreover, the graphical representation may include a circle, locus, or other shape which defines the boundaries of audience members targeted by the advertisement campaign currently being analyzed. Thus, the graphical representation may provide an illustration similar to a Venn diagram that illustrates the users targeted by the advertisement campaign based on the audience segment associated with that campaign.

In some embodiments, the graphical representation may include a first locus or shape that represents the original audience segment that was initially received and only includes seed data categories. The graphical representation may further include a second locus or shape that represents the augmented or expanded audience segment that results from the inclusion of additional candidate data categories based on a recommended extension. Moreover, the graphical representation may include additional loci or shapes that represent other expanded audience segments that may result from including different sets of candidate data categories as may result, for example, from the adjustment of weighted parameters, as discussed above with reference to FIG. 7. Thus, the graphical representation, may simultaneously display an illustration of different audiences targeted by different recommended audience extensions. Furthermore, the graphical representation may also include estimated costs and additional impressions for each one. Thus, an entity, such as the advertiser, may be able to compare different recommended audience extensions based on the data values and illustrations displayed in the graphical representation.

Method 700 may proceed to operation 710 during it may be determined whether or not additional changes have been made. As similarly discussed above with reference to FIG. 6, such a determination may be made based on an input received from an entity or an automated process executed by a system component. If it is determined that no additional changes have been made, method 700 may terminate. If it is determined that additional changes have been made, method 700 may return to operation 702, and method 700 may repeat.

FIG. 8 illustrates and example of a user interface screen implemented in accordance with some embodiments. In various embodiments, a user interface screen, such as user interface screen 800, may include one or more data fields configured to receive one or more inputs from an entity, such as an advertiser, and further configured to display various information to the entity. In this way, the user interface screen may receive inputs from the advertiser and may also display various information characterizing recommended audience extensions that have been generated based on the received inputs.

In some embodiments, user interface screen 800 may include at least one data field configured to receive an input from and entity, such as an advertiser. The input may identify or characterize a value or adjustment to one or more weighted parameters, as similarly discussed above with reference to FIG. 6. In some embodiments, user interface screen 800 may include data field 802 which may be configured to identify one or more data values characterizing a first weighted parameter associated with a first metric. For example, data field 802 may be configured to identify a first weighted parameter for a similarity metric. Accordingly, data field 802 may include a slider which may be configurable by the entity to identify a particular data value. In this example, the data value may be a number between 0 and 1. Thus, an entity, such as an advertiser, may set the slider to a particular value between 0 and 1, and the set value may identify the value of the weighted parameter for the similarity metric and relevance scores and recommendations generated based, at least in part, on the similarity metric. Similarly, user interface screen 800 may also include data field 804 which may be configured to identify a second weighted parameter for a novelty metric, and data field 806 which may be configured to identify a third weighted parameter for a performance metric.

In some embodiments, user interface screen 800 may also include data field 808 which may include several other data field that provide various information about recommended audience extensions that have been generated based on weighted parameters. For example, data field 808 may include data field 810 which may display modified audience segments that have been generated as recommended audience extensions. Thus, data field 810 may provide information that identifies the modifications that have been made for each recommended audience extension. In some embodiments, such information may be displayed as a series of rule statements, or may be provided as one or more illustrations in a graphical representation.

In various embodiments, data field 808 may further include data field 812 which may identify a total number of users or audience members that are targeted by the recommended audience extension. Furthermore, data field 808 may also include data field 814 which may identify an overall similarity score that characterizes a similarity between the recommended audience extension and the original audience segment. In some embodiments, such an overall similarity score may be determined by averaging the similarity metrics associated with each candidate data category that has been included in the recommended audience extension. Moreover, data field 808 may also include data field 816 which may identify an overall novelty score that characterizes the novelty of the group of users targeted by the recommended audience extension when compared with the group of users targeted by the original audience segment. As similarly discussed above, an overall novelty score may be determined by averaging the novelty metrics associated with each candidate data category that has been included in the recommended audience extension.

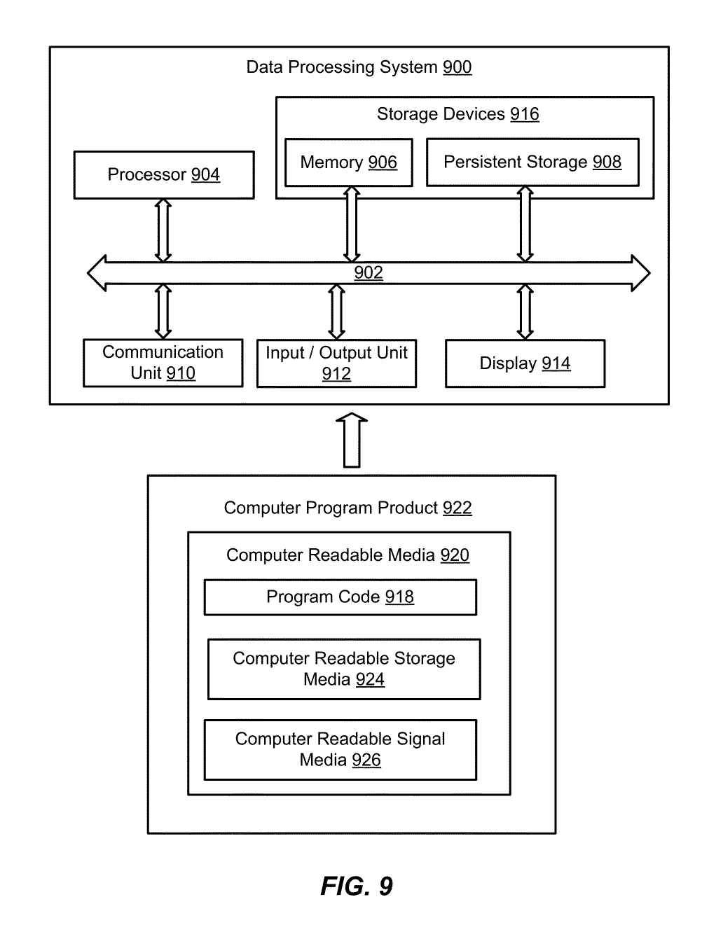

FIG. 9 illustrates a data processing system configured in accordance with some embodiments. Data processing system 900, also referred to herein as a computer system, may be used to implement one or more computers or processing devices used in a controller, server, or other components of systems described above, such as an audience segment analyzer. In some embodiments, data processing system 900 includes communications framework 902, which provides communications between processor unit 904, memory 906, persistent storage 908, communications unit 910, input/output (I/O) unit 912, and display 914. In this example, communications framework 902 may take the form of a bus system.

Processor unit 904 serves to execute instructions for software that may be loaded into memory 906. Processor unit 904 may be a number of processors, as may be included in a multi-processor core. In various embodiments, processor unit 904 is specifically configured and optimized to process large amounts of data that may be involved when processing data associated with audience segments and associated candidate data categories, as discussed above. Thus, processor unit 904 may be an application specific processor that may be implemented as one or more application specific integrated circuits (ASICs) within a processing system. Such specific configuration of processor unit 904 may provide increased efficiency when processing the large amounts of data involved with the previously described systems, devices, and methods. Moreover, in some embodiments, processor unit 904 may be include one or more reprogrammable logic devices, such as field-programmable gate arrays (FPGAs), that may be programmed or specifically configured to optimally perform the previously described processing operations in the context of large and complex data sets sometimes referred to as “big data.”

Memory 906 and persistent storage 908 are examples of storage devices 916. A storage device is any piece of hardware that is capable of storing information, such as, for example, without limitation, data, program code in functional form, and/or other suitable information either on a temporary basis and/or a permanent basis. Storage devices 916 may also be referred to as computer readable storage devices in these illustrative examples. Memory 906, in these examples, may be, for example, a random access memory or any other suitable volatile or non-volatile storage device. Persistent storage 908 may take various forms, depending on the particular implementation. For example, persistent storage 908 may contain one or more components or devices. For example, persistent storage 908 may be a hard drive, a flash memory, a rewritable optical disk, a rewritable magnetic tape, or some combination of the above. The media used by persistent storage 908 also may be removable. For example, a removable hard drive may be used for persistent storage 908.

Communications unit 910, in these illustrative examples, provides for communications with other data processing systems or devices. In these illustrative examples, communications unit 910 is a network interface card.

Input/output unit 912 allows for input and output of data with other devices that may be connected to data processing system 900. For example, input/output unit 912 may provide a connection for user input through a keyboard, a mouse, and/or some other suitable input device. Further, input/output unit 912 may send output to a printer. Display 914 provides a mechanism to display information to a user.

Instructions for the operating system, applications, and/or programs may be located in storage devices 916, which are in communication with processor unit 904 through communications framework 902. The processes of the different embodiments may be performed by processor unit 904 using computer-implemented instructions, which may be located in a memory, such as memory 906.

These instructions are referred to as program code, computer usable program code, or computer readable program code that may be read and executed by a processor in processor unit 904. The program code in the different embodiments may be embodied on different physical or computer readable storage media, such as memory 906 or persistent storage 908.

Program code 918 is located in a functional form on computer readable media 920 that is selectively removable and may be loaded onto or transferred to data processing system 900 for execution by processor unit 904. Program code 918 and computer readable media 920 form computer program product 922 in these illustrative examples. In one example, computer readable media 920 may be computer readable storage media 924 or computer readable signal media 926.

In these illustrative examples, computer readable storage media 924 is a physical or tangible storage device used to store program code 918 rather than a medium that propagates or transmits program code 918.

Alternatively, program code 918 may be transferred to data processing system 900 using computer readable signal media 926. Computer readable signal media 926 may be, for example, a propagated data signal containing program code 918. For example, computer readable signal media 926 may be an electromagnetic signal, an optical signal, and/or any other suitable type of signal. These signals may be transmitted over communications links, such as wireless communications links, optical fiber cable, coaxial cable, a wire, and/or any other suitable type of communications link.

The different components illustrated for data processing system 900 are not meant to provide architectural limitations to the manner in which different embodiments may be implemented. The different illustrative embodiments may be implemented in a data processing system including components in addition to and/or in place of those illustrated for data processing system 900. Other components shown in FIG. 9 can be varied from the illustrative examples shown. The different embodiments may be implemented using any hardware device or system capable of running program code 918.

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatus. Accordingly, the present examples are to be considered as illustrative and not restrictive.

What is claimed is:

1. A system comprising:
a first processing node configured to generate a first plurality of data values identifying a first plurality of data categories, the first plurality of data categories including a plurality of seed data categories identifying a set of characteristics of a first plurality of users associated with an advertisement campaign;
a query node configured to retrieve a second plurality of data values identifying a second plurality of data categories, the second plurality of data categories including a plurality of candidate data categories identifying a set of characteristics of a second plurality of users associated with historical data aggregated from a plurality of advertisement campaigns;
a second processing node configured to generate a plurality of relevance metrics including a relevance metric for each candidate data category of the plurality of candidate data categories based on a comparison between each of the plurality of seed data categories and each of the plurality of candidate data categories; and
a third processing node configured to generate a third plurality of data values identifying a third plurality of data categories, the third plurality of data categories including at least some of the plurality of seed data categories and at least some of the plurality of candidate data categories based on the generated plurality of relevance metrics.

2. The system of claim 1, wherein the plurality of seed data categories are identified based on a plurality of targeting criteria associated with the advertisement campaign.

3. The system of claim 1, wherein the second processing node is further configured to:
generate a plurality of similarity metrics including a similarity metric for each candidate data category of the plurality of candidate data categories, wherein each similarity metric of the plurality of similarity metrics identifies a probability that a seed data category of the plurality of seed data categories is associated with the same user as a candidate data category of the plurality of candidate data categories.

4. The system of claim 3, wherein the second processing node is further configured to:
generate a plurality of novelty metrics including a novelty metric for each candidate data category of the plurality of candidate data categories, wherein each novelty metric of the plurality of novelty metrics identifies a probability that a candidate data category of the plurality of candidate data categories is associated with a different user as a seed data category of the plurality of seed data categories.

5. The system of claim 4, wherein the second processing node is further configured to:
generate a plurality of performance metrics including a performance metric for each candidate data category of the plurality of candidate data categories based on a return on investment associated with an advertisement campaign that includes the candidate data category.

6. The system of claim 5 further comprising:
a fourth processing node configured to generate a plurality of weighted parameters including a weighted parameter for each of the plurality of similarity metrics, the plurality of novelty metrics, and the plurality of performance metrics for each combination of the plurality of seed data categories and the plurality of candidate data categories; and
a fifth processing node configured to generate a fourth plurality of data values identifying a plurality of relevance scores based on the plurality of weighted parameters, the plurality of relevance scores including a relevance score for each combination of the plurality of seed data categories and the plurality of candidate data categories.

7. The system of claim 6, wherein the third plurality of data categories is identified based, at least in part, on the plurality of relevance scores.

8. The system of claim 7, wherein the fourth processing node is further configured to modify at least one of the plurality of weighted parameters, and wherein the fifth processing node is further configured to generate a fifth plurality of data values identifying a plurality of updated relevance scores based, at least in part, on the received at least one modification.

9. The system of claim 8, wherein the modifying of the at least one of the plurality of weighted parameters is based, at least in part, on historical data characterizing at least one previous modification.

10. The system of claim 8, wherein the third processing node is further configured to generate a sixth plurality of data values identifying a fourth plurality of data categories, the fourth plurality of data categories including at least some of the plurality of seed data categories and at least some of the plurality of candidate data categories, the fourth plurality of data categories being identified based, at least in part, on the plurality of updated relevance scores.

11. The system of claim 10 further comprising a sixth processing node configured to generate a graphical representation of fourth plurality of data categories, and further configured to send the graphical representation to a display device associated with a user.

12. The system of claim 1, wherein the first processing node, the second processing node, and the third processing node are the same processing node.

13. A device comprising:
an audience segment analyzer configured to:
generate a first plurality of data values identifying a first plurality of data categories, the first plurality of data categories including a plurality of seed data categories identifying a set of characteristics of a first plurality of users associated with an advertisement campaign;
retrieve, via a communications interface, a second plurality of data values identifying a second plurality of data categories, the second plurality of data categories including a plurality of candidate data categories identifying a set of characteristics of a second plurality of users associated with historical data aggregated from a plurality of advertisement campaigns;
generate a plurality of relevance metrics including a relevance metric for each candidate data category of the plurality of candidate data categories based on a comparison between each of the plurality of seed data categories and each of the plurality of candidate data categories; and
generate a third plurality of data values identifying a third plurality of data categories, the third plurality of data categories including at least some of the plurality of seed data categories and at least some of the plurality of candidate data categories based on the generated plurality of relevance metrics.

14. The device of claim 13, wherein the audience segment analyzer is further configured to execute one or more instructions to:
generate a plurality of similarity metrics including a similarity metric for each candidate data category of the plurality of candidate data categories, wherein each similarity metric of the plurality of similarity metrics identifies a probability that a seed data category of the plurality of seed data categories is associated with the same user as a candidate data category of the plurality of candidate data categories.

15. The device of claim 14, wherein the audience segment analyzer is further configured to execute one or more instructions to:
generate a plurality of novelty metrics including a novelty metric for each candidate data category of the plurality of candidate data categories, wherein each novelty metric of the plurality of novelty metrics identifies a probability that a candidate data category of the plurality of candidate data categories is associated with a different user as a seed data category of the plurality of seed data categories.

16. The device of claim 15, wherein the audience segment analyzer is further configured to execute one or more instructions to:
generate a plurality of performance metrics including a performance metric for each candidate data category of the plurality of candidate data categories based on a return on investment associated with an advertisement campaign that includes the candidate data category.

17. The device of claim 16, wherein the audience segment analyzer is further configured to execute one or more instructions to:
generate a plurality of weighted parameters including a weighted parameter for each of the plurality of similarity metrics, the plurality of novelty metrics, and the plurality of performance metrics for each combination of the plurality of seed data categories and the plurality of candidate data categories; and
generate a fourth plurality of data values identifying a plurality of relevance scores based on the plurality of weighted parameters, the plurality of relevance scores including a relevance score for each combination of the plurality of seed data categories and the plurality of candidate data categories.

18. The device of claim 17, wherein the third plurality of data categories is identified based, at least in part, on the plurality of relevance scores.

19. One or more computer readable media having instructions stored thereon for performing a method, the method comprising:
generating a first plurality of data values identifying a first plurality of data categories, the first plurality of data categories including a plurality of seed data categories identifying a set of characteristics of a first plurality of users associated with an advertisement campaign;
retrieving a second plurality of data values identifying a second plurality of data categories, the second plurality of data categories including a plurality of candidate data categories identifying a set of characteristics of a second plurality of users associated with historical data aggregated from a plurality of advertisement campaigns;
generating a plurality of relevance metrics including a relevance metric for each candidate data category of the plurality of candidate data categories based on a comparison between each of the plurality of seed data categories and each of the plurality of candidate data categories; and
generating a third plurality of data values identifying a third plurality of data categories, the third plurality of data categories including at least some of the plurality of seed data categories and at least some of the plurality of candidate data categories based on the generated plurality of relevance metrics.

20. The one or more computer readable media recited in claim 19, wherein the plurality of seed data categories are identified based on a plurality of targeting criteria associated with the advertisement campaign.
